(19) United States
(12) Patent Application Publication
(10) Pub. No.: US 2004/0205630 A1
(43) Pub. Date: Oct. 14, 2004

(54) System and method for application entitlement

(76) Inventors: Jeff A. Parks, Santa Clara, CA (US); Yu Hong (Lucy) Shao, Sunnyvale, CA (US); Peter Christopher Johnson II, Riverside, CA (US)

Correspondence Address: HEWLETT-PACKARD COMPANY, Intellectual Property Administration, P. O. Box 272400, Fort Collins, CO, 80527-2400, US

(21) Appl. No.: 09/939,095

(22) Filed: Aug. 24, 2001

(51) Int. Cl. G06F 15/00

(52) U.S. Cl. 715/526; 715/500; 715/517

(57) ABSTRACT

A system and method for providing an entitled application screen in response to a software application or presentation object's request to a database and its associated business rule objects. The method includes the step of requesting a portion of an application screen from the database and business rule objects. Another step is identifying the application screen returned for display. The application screen returned can be different than the one requested and the system must determine which application screen has been returned. An additional step is displaying the application screen using a presentation object.

### SPECIFICATION

1. Field of the Invention

The present invention relates generally to controlling the flow of information in a computer application. More particularly, the present invention relates to controlling the entitlement of content and application screens in a computer application.

2. Background

When software developers are creating an application, it is possible to incorporate business rules and logic directly into the software application. The problem with this approach is that when the business rules for the application change, then the user interface and/or flow of the program displays must be changed. These modifications of the application can be time-consuming and expensive. In software engineering, it is valuable to be able to separate the business rules used with a computer application from the application and user interface.

When the business rules are separated from the application or client, then the business logic can be changed without requiring the application or presentation layer to be reprogrammed. For example, in a situation using client/server software, the graphical client often resides on a client computer and can request data from a database located at a separate location on a server. If the business rules are programmed at the server level, as part of the database, or as a middleware layer, then it is much easier modify the business rules without modifying the application or presentation layer.

Another example of separating the application or presentation layer from the business logic layer is a web site that is database enabled. The presentation of web pages can be separated from the business logic and database. Unfortunately, once the program logic has been divided, it can be a challenge to efficiently integrate the application and presentation layer with the database and business rule software.

### SUMMARY OF THE INVENTION

The invention provides a system and method for providing an entitled application screen in response to a software application or presentation object's request to a database and its associated business rule objects. The method includes the step of requesting a portion of an application screen from the database and business rule objects. Another step is identifying the application screen returned for display. The application screen returned can be different than the one requested and the system must determine which application screen has been returned. An additional step is displaying the application screen using a presentation object.

Another aspect of the present invention is a system for allowing a software application to request and display an entitled user screen from a database and business rules object. The system includes a presentation object that requests a user screen and data from the database and business rules object. A response table is used to translate a response user screen from the database and business rules object and to provide display properties for the response user screen when a different user screen is returned than was originally requested. A formatting object is included to format the response user screen and combine it with requested data for display.

In accordance with a more detailed aspect of the present invention, the system includes a system for formatting screens and related data to be displayed to an end user from a computer application, wherein the screen entitled to be displayed is unknown before run time. The system comprises a request index template to receive a screen request from the computer application and to retrieve a request template from a request table in order to format the screen request. A business rules engine and database are included to fulfill screen requests by returning an entitled display screen and related data. A request handler is coupled to the request index template to receive the formatted screen request, to submit the screen request to the business rules engine and database, and to receive an entitled display screen and related data. A response table associated with the request handler matches the entitled display screen to the appropriate screen response template from the response table. In addition, a template assembler assembles the entitled display screen based on the screen response template received from the request handler.

Another more detailed aspect of the present invention, includes a method for providing a screen for a computer application to be displayed to a user, wherein the screen entitled to be displayed to the user is unknown before run-time. The method comprises the step of receiving a screen request from the computer application. Another step is retrieving the request template corresponding to the screen request using a request index template. A further step is preparing a screen request query based on the request template. Yet another step is submitting the screen request query to a business rules object and database. A further step is returning an entitled screen and associated data from the business rules object and database in response to the screen request query. Then the method identifies the response template for the entitled screen that was returned. A following step is assembling the response template for the entitled screen.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a block diagram of the relationship between a presentation layer and a database and business rules layer of an application;

FIG. 2 is a block diagram of a system for application display entitlement;

FIG. 3 is a flow chart of steps that can be taken in conjunction with FIG. 1;

FIG. 4 is a block diagram illustrating a detailed embodiment of a system for application display entitlement.

### DETAILED DESCRIPTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

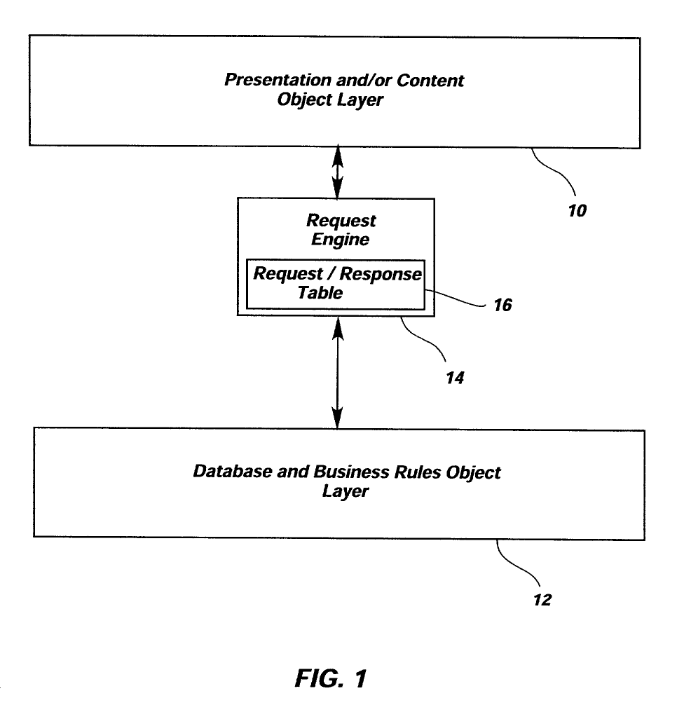

FIG. 1 illustrates a system and method for a software application that separates a presentation and/or content layer 10 from a business rules object and database layer 12. This separation is accomplished using a request engine 14 that allows the presentation layer objects to request objects such as application screens from the database and business rules object layer. A request and response table 16 or interpreter allows the request engine to identify objects that are returned in response to a request submitted to the database and business rules layer.

The configuration of the present invention can integrate the presentation layer third party software with third party software for accessing the back end database(s). One example of widely used presentation layer software is Vignette's Content Server and an example of third party software for accessing back end databases is BEA's Web Logic. The efficient and effective integration of such products provides cost effective maintenance and higher performance applications.

Often the database access software layer can include an implementation that holds the information to determine the pre-requisites for viewing each application screen (known as business logic). This business rules and database layer can also offer a set of servlets that expect an HTTP request with embedded XML as a gateway to its feature set. This integration configuration allows the application developer to display web pages or application screens using the present invention.

It is useful from a software maintenance standpoint to take advantage of the business rule storage capabilities of the business rules object layer while still taking advantage of the caching capabilities of the presentation layer (e.g., Vignette). Then the system can store ever-changing business rules in one place and only execute business rule scripts during runtime when absolutely needed. This present invention provides both of these features.

One feature of the present invention that can take advantage of the strengths of both the presentation layer and the database and business rules layer has to do with the separation of the screen entitlement from the presentation layer. Entitlement is generally defined in this description as the logic that controls which application screen can be displayed after an application screen or user interface screen has been requested. In other words, entitlement asks the question, “The user would like to view application screen Z. What screen can the user actually view?” A response to this request can be “Here is the screen the user can view.” This is sometimes referred to as a check of prerequisites.

An example of entitlement is where the application user would like to view one screen or web page, say the Hardware Call Logging screen, but based on a variety of factors may instead have another screen rendered or presented instead, like a Login screen, Knowledge Menus screen, or an error screen.

In a conventional application, when a request to view a certain application screen is made and cannot be fulfilled, then defined error codes are returned to the calling object, function or procedure. The program logic on the presentation side must then decide what to do with the error that has been returned and re-request another screen based on the user's entitlement. This requires additional processing on the presentation side and at least one extra screen display request. An increase in system speed can be the result of avoiding this extra processing and extra screen display request.

As part of a screen request, the system of the present invention first asks the general entitlement question. In contrast to the prior art, the intent of the request in this invention is understood to mean that the system should not return an error, but return a screen the user is allowed to view. This means that the answer to the initial question may be something entirely different than what was requested. In other words, the requesting program cannot determine in advance the viewable screen the business logic and database will return. Further, by asking the question as generally as this, the requested engine can be put in place to invoke the presentation logic based on the answer received.

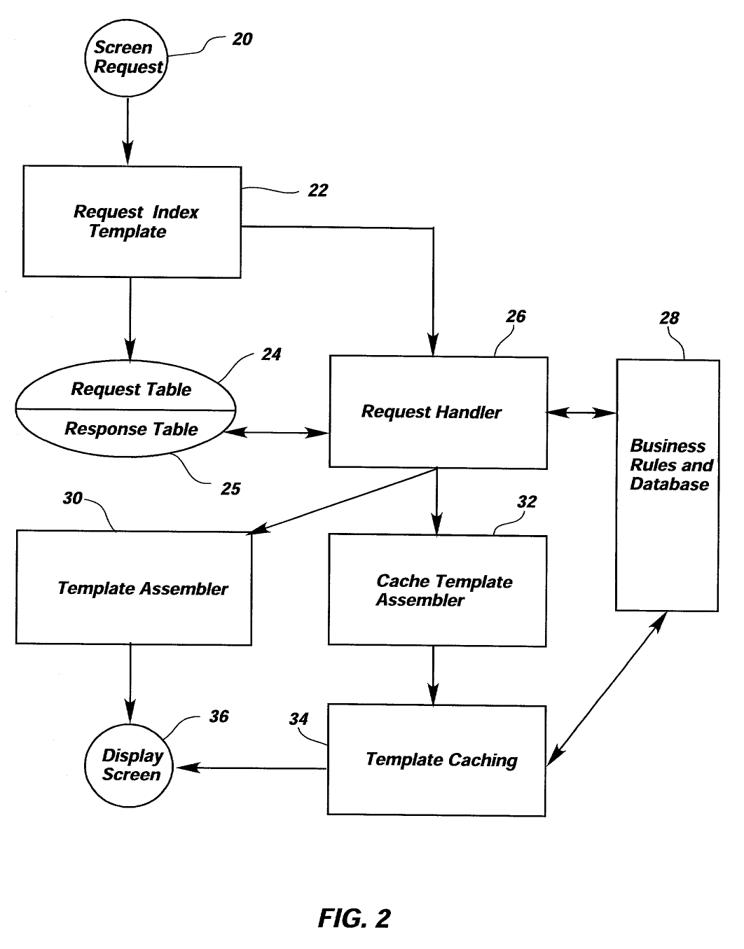

FIG. 2 illustrates a system and method for presenting screens and content to be displayed to an end user from a computer application when the screen that is entitled to be displayed to a user is unknown before run time. The initial screen request 20 is received by a request index template 22 in the presentation object. The request index template looks up the request template in the request table 24 of the presentation object database (e.g., a Vignette database).

The request template is further processed by the request index template to include any screen parameters passed with the screen request. The purpose of the request template and the associated library is to formulate the XML needed as input for the screen's database call. The screen and form parameters are combined with the library template to create at least one query that can be sent to the business rules object and database. The query is preferably formatted in extended markup language (XML) but it can also be formatted in structured query language (SQL) or another database language for making the database request. The request handler 26 then submits the screen request from the business rules object and database 28 and receives the results of this request. The data that may be returned from the database can include e-commerce information, accounting information or similar information that will be embedded into the user screen.

Since the user interface screen response received from the database is not necessarily the screen that was requested, the request handler 26 must resolve the screen response. The result returned is preferably a data set or data type that defines the screen response but it can also include a screen name. The request handler looks up the screen that is returned in the response table 25 to retrieve the appropriate response template from the response library. If no data caching is required and the request has returned screen data, the selected response template and data set are then combined in the template assembler 30 and the screen is displayed 36.

If caching is required, then the selected response template is prepared but no data is returned with the first call from the database. The response template is the passed to the cache template assembler 34. A second call is then made to the database requesting the screen data. This reduces the number of calls requesting data from the database so that the overhead cost of database processing can be reduced. The data returned is combined with the assembled response template from the response library and the data is also cached for later use. Of course, if the data already exists in the caching system it will not be retrieved from the database but from the caching file system. Once the cached data has been combined with the response template, the screen is displayed 36.

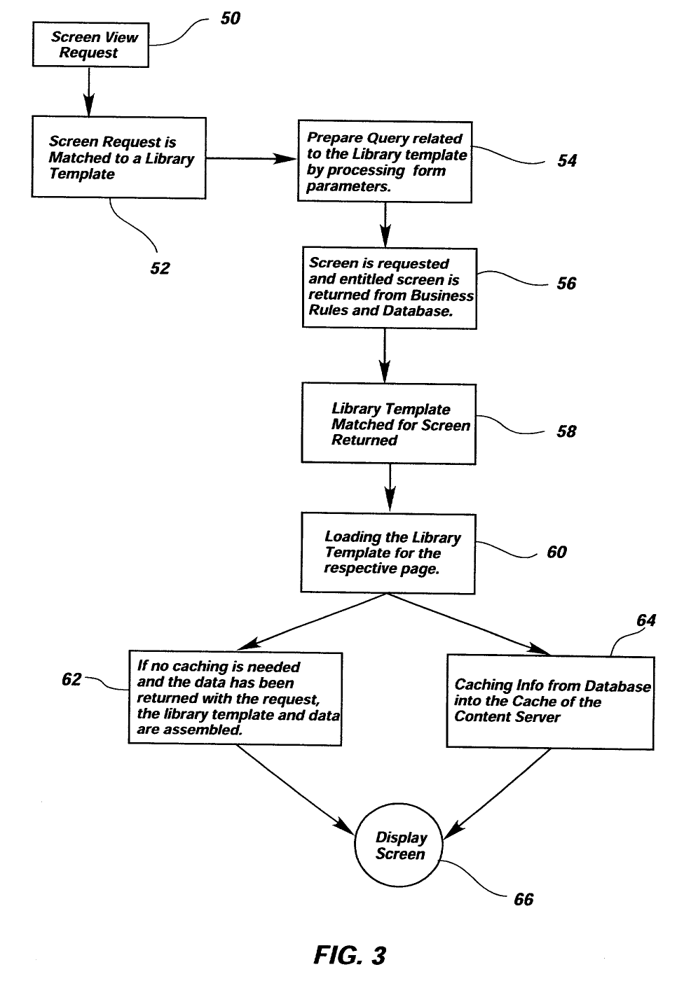

FIG. 3 illustrates a method to provide entitled screen output when the entitlement is not known at software application design time. The first step is receiving a screen view request from the computer application or web application 50. The screen request template is matched to the corresponding screen request 52. A query is then prepared that relates to the screen request template and includes the screen parameters that were passed with the screen view request. For example, the screen can contain a network browser or Java enabled form that can receive data entries from the user and transmit them as POST variables that are embedded in a universal resource locator (URL) or web link. The prepared query will be in XML, SQL or some other defined database query language.

The screen request is submitted to a business rule engine and database. In response, the business rules and database return an entitled screen and possibly data that are associated with the entitled screen 56. The entitled screen is matched to the response library template for the entitled screen that was returned 58. A response template is a plurality of presentation components or graphical user interface definitions that determine how a screen will be displayed to a user on their computer or through a web browser.

Another step is the library template that was selected is loaded and assembled 60. If the entitled screen returned from the database contains data, then the assembled library template is combined with the data 62 and the requested screen is displayed 66. If the screen request does not contain data, a second request is made for the data through the caching portion of the content or presentation server 64. If the requested data has been previously cached, then the data is retrieved from the caching file system. The cached data can then be combined with the response template and displayed 66.

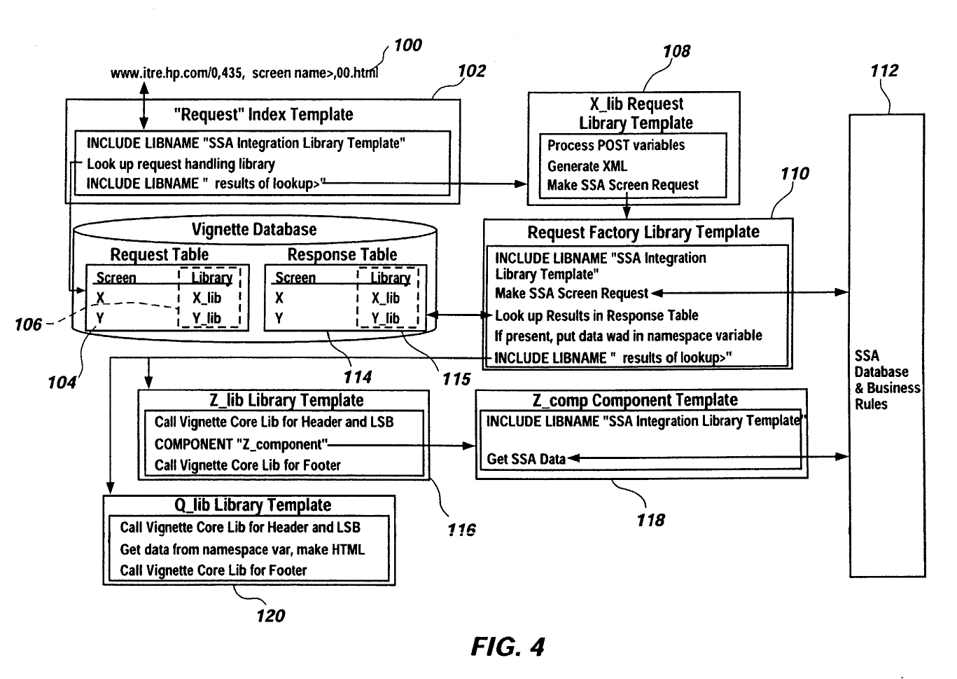

FIG. 4 illustrates a more detailed embodiment of a system and method that effectively separates screen entitlement from screen presentation in an application. A screen view request or URL containing a screen request is received for a particular screen 100. The request index template 102 handles the request. The request index template takes the screen request and looks it up in the database request table 104 to get a mapping to a request library template 106.

The request library template 108 prepares the screen and form variables posted in the request and formats those variables into XML. The included request library template processes any possible POST variables (e.g., form variables) and creates the XML structure that the business rules and database objects are expecting. This detailed embodiment illustrates that a database contained in Vignette® can be used to store the request table. The request factory library template 110 accepts the formatted screen request, and the screen request is submitted to the business rules and database 112. Although the business rules and database are represented here as one object, they could also be separate objects that are in electronic communication with each other.

The response or user interface screen that comes back in the request is looked up in the response table 114 and the correct response library 115 is included. The screen returned is generally not a screen name, but the response is often a finite set of data and a data type that comes back from the database call. If any data is passed back with the screen identification to render, it is stored in a pre-defined namespace variable. If there are no errors, this causes the response library to be invoked. It uses the presentation components used in the response library to paint a majority of the page, including the response payload from database.

Data can and typically does come back in the first response from the business rules and database object. On the other hand, if the screen has cacheable content based on data from the database, it is better to avoid retrieving data with the first response. Instead, a second call to the database can be made from within a cacheable component (from the content server). Since this data is cacheable, this second call will be made only once. This prevents the data from being sent with every call but used only once. For the caching cases, the application developer can make a call to the database using the content server component that makes the second call into the database infrastructure.

There are generally two paths that the rendering library template or response template can take (illustrated as the Z_lib Library Template 116 and Q_lib Library template 120). The rendering library template can include a cached presentation component, which in turn makes other calls 118 to the database to get data it then caches. This caching path is illustrated by the Z_lib library template block 116 and the Z_comp component template block 118. Alternatively, the rendering library template takes data from the well-known namespace variable 120 and paints the screen that was returned from the request.

In the caching case 116, 118, it is likely that no data will come back from the first database call, but it can all be bundled into the second call. In the non-caching case 120, the data is obtained from the namespace variable since all of the necessary data is obtained from the first and only call.

The figures have not illustrated the registration process application developers use to prepare a request and response table or interpreter to tell the system which libraries map to which screen names and possible database responses. This will be discussed in further detail below. The application developers will not need to deal with all of the details of the integration as it is presented above. The developer can follow certain steps to integrate their application screens with the business rules and database infrastructure.

First, the application developer can create a request library. As mentioned, the request library is used to formulate the XML needed as input in the database call for the screen request. The request can make a call to the business rules and database object by passing in the name of the request and the XML bundle expected as input for that request.

An application developer also creates a response library. This response library generally incorporates user interface formats and screen formats for the software application and paints the screen back to the user. The content and presentation layer (or server) are used to paint the navigational aspects to the screen.

The screen name is entered by the application developer into the request library mapping. This design time step is preferably performed through a web page that can access the request table in the content and presentation server. The screen name can also be entered directly into the request table through some other electronic interface. The entry interface writes data into the request table in the content server database and enables the call chaining necessary to make the screen request from the business rules database. The screen name entered in this specific embodiment will be a URL but it could be defined in other ways as needed.

The application developer also enters the database response type for the response table (and response library mapping). Similar to the request table mapping (and request library mapping), this design time step can be performed through a web page or a direct table entry. This mapping helps make the scheme work, and enables the proper code sequencing to occur when a response (other than the one requested) is received back from the business rules and database. The string that is entered here can be the response type that is expected to come back from the business rules and database. The response table and library use a first variable to hold database response header information and a second variable to hold the contents of the screen response. It is this header information in the response table and library that is compared to the header returned from the business rules and database.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in implementation, form, function and manner of operation, assembly and use may be made, without departing from the principles and concepts of the invention as set forth in the claims.

What is claimed is:

1. A method for providing an entitled application screen in response to a presentation object's request to a database and its associated business rule objects, comprising the steps of:
requesting at least a portion of an application screen from the database and business rule objects;
identifying the application screen returned for display, wherein the application screen returned can be different than the one requested; and
displaying the application screen using the presentation object.

2. A method as in claim 1, further comprising the step of identifying the application screen using a response table that contains display library.

3. A method as in claim 2, wherein the identifying step further comprises the step of formatting the application screen returned for display using the display library returned from the response table.

4. A method as in claim 1, wherein the identifying step further comprises the step of formatting the application screen returned for display.

5. A method as in claim 1, further comprising the step of identifying the application screen using an interpreter to identify the application screen returned and provides display formatting components.

6. A method as in claim 1, further comprising the step of linking the presentation object and the database and business rules object, via a request and response table.

7. A method of allowing a presentation object to request and display an entitled user screen from a database and business rules object, comprising the steps of:
requesting a user screen desired to be displayed, from the database and business rules object;
receiving a user screen response back from the database and business rules object, wherein the user screen response can be a different user screen than requested;
identifying the user screen response that has been returned; and
formatting the user screen response for display through the presentation object based on the identified user screen response.

8. A method as in claim 7, further comprising the step of identifying the user screen response using a response table that contains display formatting components.

9. A method as in claim 7, wherein the formatting step further comprises the step of formatting the user screen response returned for display using the display formatting components returned from the response table.

10. A system for allowing a software application to request and display an entitled user screen from a database and business rules object, comprising:
a presentation object that requests a user screen and data from the database and business rules object;
a response table to translate a response user screen from the database and business rules object and to provide display properties for the response user screen when a different user screen is returned than was originally requested;
a formatting object to format the user screen and combine it with requested data for display.

11. A system as in claim 10 wherein the presentation object is a networked content server.

12. A system as in claim 10 wherein the formatting object formats the user screens using a markup language.

13. A system for formatting screens and related data to be displayed to an end user from a computer application, wherein the screen entitled to be displayed is unknown before run time, comprising:
a request index template to receive a screen request from the computer application and retrieve a request template from a request table in order to format the screen request;
a business rules engine and database to fulfill screen requests by returning an entitled display screen and related data;
a request handler, coupled to the request index template, to receive the formatted screen request, to submit the screen request to the business rules engine and database, and then to receive an entitled display screen and related data;
a response table associated with the request handler, wherein the request handler matches the entitled display screen to the appropriate screen response template from the response table; and
a template assembler to assemble the entitled display screen based on the screen response template received from the request handler.

14. A system in accordance with claim 13 wherein the template assembler further comprises a caching template assembler to make a second request to the business rules engine and database for data which will be stored in a template caching unit.

15. A system in accordance with claim 13 wherein the screen request is for a web page.

16. A system in accordance with claim 13 wherein the request index template, the request and response tables, and the request handler are located within a presentation content server.

17. A method for providing a screen for a computer application to be displayed to a user, wherein the screen entitled to be displayed to the user is unknown before run-time, comprising the steps of:
receiving a screen request from the computer application;
retrieving the request template corresponding to the screen request using a request index template;
preparing a screen request query based on the request template;
submitting the screen request query to a business rules object and database;
returning an entitled screen and associated data from the business rules object and database in response to the screen request query;
identifying the response template for the entitled screen that was returned; and
assembling the response template for the entitled screen.

18. A method as in claim 17, further comprising the step of displaying the entitled screen by combining data from the database and formatting from components loaded with the response template.

19. A method as in claim 17, further comprising the step of storing the computer application on a content and presentation server.

20. A method as in claim 17, further comprising the step of making a second request to the business rules object and database to obtain data for the entitled screen and caching the data from the second request.
